(19) United States
(12) Patent Application Publication
(10) Pub. No.: US 2011/0265361 A1
(43) Pub. Date: Nov. 3, 2011

(54) Wrap-Mount Fabric Display System

(76) Inventor: Robert M. Frey, Salt Lake City, UT (US)

(21) Appl. No.: 12/771,312

(22) Filed: Apr. 30, 2010

(51) Int. Cl. G09F 7/00

(52) U.S. Cl. 40/603

(57) ABSTRACT

A wrap-mount fabric display system comprises an outer frame element, an inner frame element and one or two flexible display substrates. The inner frame element includes two rigid panels maintained at a fixed distance apart from one another by way of one or more connective members. The flexible display substrates each include a graphic design and can be removably placed in wrapped association with a respective panel, which secures the flexible display substrate in tension. The frame elements can be manufactured from flat stock materials which are relatively inexpensive to purchase and shape. Once a flexible display substrate is placed in wrapped association with a respective panel, the inner frame element can be inserted into the cavity of the outer frame element to create a cost-effective, flexible and robust integrated display solution.

### RELATED APPLICATIONS

Not Applicable.

### TECHNICAL FIELD OF THE INVENTION

The present invention relates generally to the field of graphic display systems. More particularly, the invention concerns graphic display systems comprising a framework which supports flexible display substrates, such as those commonly used for decoration and advertising in retail establishments, trade shows, and the like.

### BACKGROUND OF THE INVENTION

The use of fabric as a graphic display substrate is gaining popularity in the retail environment due to its aesthetically pleasing quality and ease of storage and shipping. However, relying on conventional methods for creating specialized frame members of various sizes and shapes for individual retail applications using fabric as a display medium can be costly and time-consuming. Retail display environments typically require lower-cost solutions that can be manufactured in a relatively short lead time, while allowing the rapid substitution of graphic designs.

Display systems for retail environments typically consist of a series of outer frame members that are assembled to define the general size and shape of the display. The opening or interior space created by the frame is then typically filled or covered with a rigid or flexible panel supporting a graphic design. In display solutions that rely on rigid panels to support the graphic design, it is common for the panel to be vertically stabilized and axially secured within the frame assembly by way of engagement between the rigid display panel and, for example, a lip or rabbet formed as part of the outer frame. Reliance on such conventional frame features to provide stability and securement of the display panel typically drives up the cost and complexity of the display system, particularly in the case of display systems adapted to display two different images in independent directions.

Durable outer frames with integrally formed lips and rabbets can be costly to produce, particularly when the outer frame comprises metal extrusions which must be uniquely adapted to generate various framework shapes, sizes and joint angles. Further, such prior display systems typically require additional hardware or numerous welding operations to interconnect the multiple outer frame segments to form a completed framework.

Conventional frame features such as lips and rabbets also tend to hinder the rapid removal of a rigid display panel from the outer frame when the graphic design supported by the panel is being substituted with another graphic design. Moreover, it is common for display systems in the retail environment to feature graphic designs which are permanently printed on or affixed to a rigid display panel, requiring the disposal of the rigid display panel along with the graphic design affixed thereto when the graphic design is no longer useful. Naturally, such systems generally require replacement graphics to be shipped to the retailer along with a new rigid panel, thereby increasing the cost of production and shipment of the new graphic design.

Although those in the art recognize the need for a more efficient and less-expensive display solution, significant challenges are presented when attempting to rely on less-expensive materials and manufacturing techniques to produce a framework rigid enough to stand up to aggressive handling in the retail environment while continuously supporting a fabric display substrate in tension for several months or years. These challenges are compounded when the display system is intended to enable the rapid substitution of graphic designs, display two different graphic designs in independent directions and, in some applications, provide internal storage space for shipping and stocking purposes.

Accordingly, what is needed is a robust, stable, low-cost, fabric display system which can take on a variety of shapes and sizes, leverage low-cost construction materials and less-complex manufacturing processes, facilitate rapid substitution of graphic designs, allow two graphic designs to be simultaneously displayed in independent directions, offer internal storage space and provide sufficient structural rigidity to support fabric display substrates in tension for extended periods of time within the retail environment.

### SUMMARY OF THE INVENTION

Rather than relying on a single, more complex display frame profile to simultaneously define the size and shape of the display and secure the fabric display substrate in tension, embodiments according to the present invention essentially divide these structural roles into two discrete frame elements, allowing more readily available and lower cost materials of construction to be used. The inner frame element with a fabric wrapped panel is slid inside the cavity of the outer frame element to create an integrated display solution.

By way of summary, embodiments concern a wrap-mount fabric display system comprising an outer frame element, an inner frame element and at least a first display substrate. The outer frame element has a main axis, a multiplicity of generally uninterrupted planar sides distributed thereabout, a first peripheral edge and a second peripheral edge. The sides of the outer frame element may be flat planar or curved planar, and generally define a lateral periphery of a cavity. The cavity is generally axially open and has a depth oriented along the main axis.

The inner frame element is adapted to be axially inserted into the cavity toward an inserted configuration. The inner frame element includes a first panel, a second panel and at least one connective member disposed therebetween. The first panel has a first panel inner face, a first panel outer face and a first panel peripheral edge. Similarly, the second panel has a second panel inner face, a second panel outer face and a second panel peripheral edge. The first panel peripheral edge and second panel peripheral edge each typically have the same number of sides as the outer frame element. The first panel outer face is typically approximately adjacent to the first peripheral edge when the inner frame element is in its inserted configuration. The first and second panels are each generally rigid.

The connective member has a first end and a second end, and is adapted for attachment to the first panel inner face by way of the first end and to the second panel inner face by way of the second end such that the connective member maintains the first panel and the second panel at a fixed distance from one another. In certain embodiments, the fixed distance is approximately equal to the depth of the outer frame element. Further, particular embodiments may comprise a multiplicity of such connective members.

The first display substrate is generally flexible and adapted to be placed in wrapped association with the first panel such that it substantially envelops the first panel outer face, at least a portion of the first panel peripheral edge, and at least a portion of the first panel inner face. Embodiments may also comprise a second display substrate adapted to be placed in wrapped association with the second panel such that the second display substrate substantially envelops the second panel outer face, at least a portion of the second panel peripheral edge, and at least a portion of the second panel inner face.

The first and second display substrates can be comprised of fabric or other flexible material suitable for use as a substrate upon which graphics can be mounted, printed or projected. Embodiments typically comprise a first graphic design affixed to the first display substrate. Similarly, embodiments with a second display substrate typically include a second graphic design affixed thereto. The first and second display substrates may be substantially stretchable, thereby helping to retain a tensioned state when in wrapped association with a respective panel.

In certain embodiments, the first display substrate and second display substrate may each include a substrate periphery and an elastic portion generally thereat. The elastic portion is adapted to removably retain the first display substrate in wrapped association with the first panel and, where applicable, the second display substrate in wrapped association with the second panel.

In embodiments, the outer frame element is typically substantially formed from flat stock of metal or plastic, the first and second panels are substantially formed of wood, cardboard, light-gauge plastic or sheet metal, and the connective members are substantially formed of wood, cardboard, light-gauge plastic or sheet metal.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a perspective view of a wrap-mount fabric display system in accordance with the present invention, shown in disassembled form;

FIG. 2 is a perspective view of a similar embodiment to that depicted in FIG. 1, but showing the inner frame element assembled, and first and second display substrates in wrapped association with first and second panels, respectively;

FIG. 3 is a perspective view of a similar embodiment to that depicted in FIG. 1, but fully assembled with the insert frame member in its inserted configuration;

FIG. 4 is a diagrammatic enlarged view of detail 4 of FIG. 2;

FIG. 5 is a diagrammatic enlarged view of detail 5 of FIG. 2;

FIG. 6 is a perspective view of a further embodiment of a wrap-mount fabric display system in accordance with the present invention, shown in disassembled form;

FIG. 7 is a perspective view of a similar embodiment to that depicted in FIG. 6, but showing the inner frame element assembled, and a first display substrate in wrapped association with a first panel;

FIG. 8 is a perspective view of another embodiment of a wrap-mount fabric display system in accordance with the present invention, shown in disassembled form;

FIG. 9 is a perspective view of a similar embodiment to that depicted in FIG. 8, but showing the inner frame element assembled, and a first display substrate in wrapped association with a first panel;

FIG. 10 is a perspective view of a similar embodiment to that depicted in FIG. 8, but fully assembled with the insert frame member in its inserted configuration;

FIG. 11 is a diagrammatic enlarged view of detail 11 of FIG. 9;

FIG. 12 is a partial cross-sectional view taken along lines 12-12 of FIG. 3, depicting a first display substrate in wrapped association a the first panel while the inner frame element is in its inserted configuration;

FIG. 13 is a partial cross-sectional view taken along lines 13-13 of FIG. 10, depicting the engagement of a connective member with a first and second panel while the inner frame element is in its inserted configuration, each panel including integrally-formed stiffeners and attachment bosses; and

FIG. 14 is a diagrammatic enlarged view of detail 14 of FIG. 13, depicting a first display substrate in wrapped association with a first panel while the inner frame element is in its inserted configuration.

While the invention is susceptible to various modifications and alternative forms, specific embodiments thereof are shown by way of example in the drawings and may herein be described in detail. The drawings may not be to scale. It should be understood, however, that the drawings and detailed description thereto are not intended to limit the invention to the particular form disclosed, but on the contrary, the intention is to cover all modifications.

### DETAILED DESCRIPTION OF THE INVENTION

Referring now to the drawings, like reference numerals designate identical or corresponding features throughout the several views.

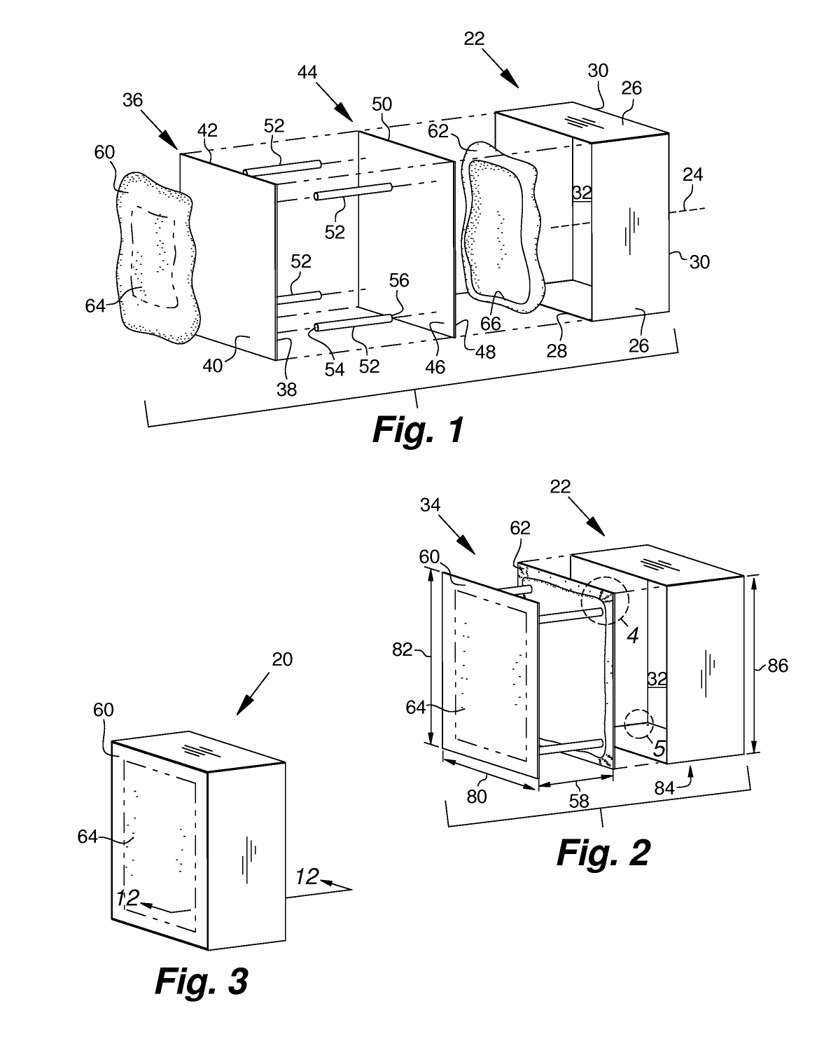

FIG. 1 depicts one embodiment of a wrap-mount fabric display system in disassembled form, a partially assembled version of which is shown at FIG. 2, and a fully assembled version of which is depicted generally at 20 in FIG. 3. With reference to FIG. 2, the embodiment comprises an outer frame element 22, an inner frame element 34, a first display substrate 60 and a second display substrate 62.

Returning to FIG. 1 for greater detail, the outer frame element 22 has a main axis 24 and a multiplicity of generally uninterrupted planar sides 26 distributed thereabout. The outer frame element 22 is typically substantially formed from flat stock of metal or plastic, such as, for example, 2 mm or 12-gauge aluminum plate. The sides 26 may be flat planar or curved planar, depending on the particular embodiment. Importantly, the use of flat stock materials and the uninterrupted planar nature of the sides 26 enable the inexpensive formation of outer frame elements 22 having a variety of sizes and shapes, such as three-dimensional squares, pentagons, octagons, semi-circles, irregular closed curves and the like.

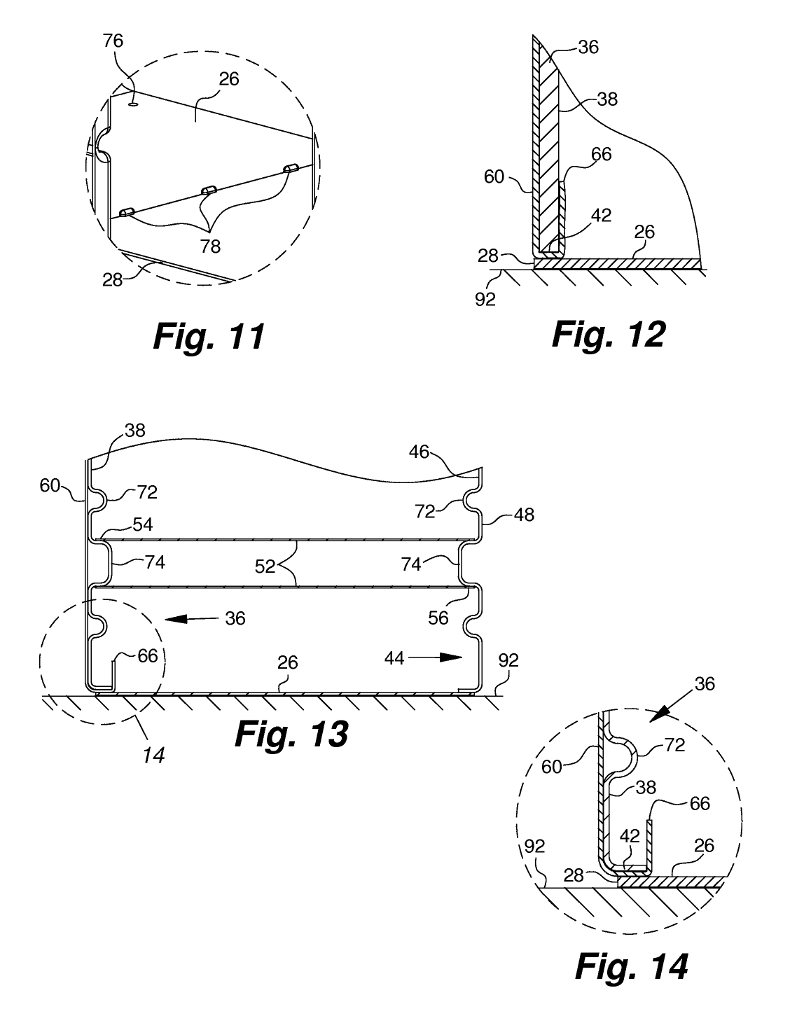

To accomplish the shaping of the outer frame member 22, for example, flat stock metal can be cut or punched to a specified flat precursor shape, then run through relatively inexpensive metal forming operations such as press brake forming or roll forming to form an outer frame element 22 with a variety of numbers of sides, those sides being flat planar, curved planar or a combination thereof. Then, as illustrated for example in FIGS. 5 and 11, the free ends of the metal stock can be affixed to one another by way of welds 78 to durably maintain the shape of the outer frame element 22. The outer frame element 22 illustrated in FIGS. 1-3, for example, may be formed with a square cross-section, each side 26 having a length of approximately two feet and a width of one foot. Returning to FIGS. 5 and 11 for illustration, if so desired, the newly-formed outer frame element can then be temporarily vertically suspended by way of a small through-hole 76 to facilitate powder coating or other coating or painting operation.

The outer frame element 22 of the embodiment shown in FIG. 1 has a first peripheral edge 28 and a second peripheral edge 30. The sides 26 of the outer frame element 22 generally define a lateral periphery of a cavity 32. The cavity 32 is generally axially open and has a depth oriented along the main axis 24. The depth of the cavity is typically the distance between the first peripheral edge 28 and the second peripheral edge 30. In certain embodiments, the first peripheral edge 28 and second peripheral edge 30 may each trace a flat plane, and those flat planes may either be parallel or angled with respect to each other.

The inner frame element 34 is generally rigid, has an inserted configuration (shown, for example, in FIGS. 3 and 10) and is adapted to be axially inserted into the cavity 32 toward its inserted configuration. Returning to FIG. 1, the inner frame element 34 includes a first panel 36, a second panel 44 and one or more connective members 52. For example, FIGS. 1-3 illustrate an embodiment with four narrower connective members 52, while FIGS. 6-7 depict an embodiment with a single broader connective member 52.

As illustrated in FIG. 1, the first panel 36 has a first panel inner face 38, a first panel outer face 40 and a first panel peripheral edge 42. The second panel 44 has a second panel inner face 46, a second panel outer face 48 and a second panel peripheral edge 50. The first panel peripheral edge 42 and second panel peripheral edge 50 each typically have the same number of sides as the outer frame element 22. The first panel outer face 40 is typically approximately adjacent to the first peripheral edge 28 when the inner frame element 34 is in its inserted configuration. However, it may be slightly inward or outward thereof, depending on the desired framing effect. Further, in embodiments in which the first peripheral edge 28 and second peripheral edge 30 each trace a flat plane and those planes are oriented at an angle with respect to each other, the first panel 36 and second panel 44 may be oriented at the same angle with respect to one another.

The connective members 52 are each generally rigid, have a first end 54 and a second end 56, and are adapted for attachment to the first panel inner face 38 by way of the first end 54 and to the second panel inner face 46 by way of the second end 56 such that the connective members 52 rigidly maintain the first panel 36 and the second panel 44 at a fixed distance 58 from one another. The fixed distance 58 is generally the distance between the first panel outer face 40 and the second panel outer face 48. In certain embodiments, the fixed distance 58 is approximately equal to the depth of the outer frame element 22. A connective member 52 may extend along a straight line or trace an irregular pathway between the first end 54 and the second end 56.

The connective members 52 may be substantially formed of wood, cardboard, light-gauge plastic or sheet metal, and may either be translucent or opaque. The attachment of the connective members to the first panel 36 and second panel 44 may be made by way of glue, weld, male/female mechanical interface or the like. The number, size and distribution of the connective members 52 are typically driven by the fixed distance 58, size and stiffness of each of the first panel 36 and second panel 44, and the degree of aggressive handling the inner frame element 34 expected to endure when in service.

Turning briefly to FIGS. 12 and 14, the first display substrate 60 is generally flexible and adapted to be placed in wrapped association with the first panel 36 such that it substantially envelops the first panel outer face 40, at least a portion of the first panel peripheral edge 42, and at least a portion of the first panel inner face 38. Similarly, embodiments such as the one depicted in FIGS. 1-3 may comprise a second display substrate 62 adapted to be placed in wrapped association with the second panel 44 such that the second display substrate 62 substantially envelops the second panel outer face 48, at least a portion of the second panel peripheral edge 50, and at least a portion of the second panel inner face 46. In further embodiments, the first or second display substrate may be directly affixed to the respective panel outer face without being placed in wrapped association with the respective panel. When in wrapped association with a respective panel, the display substrate is generally supported by the panel in tension.

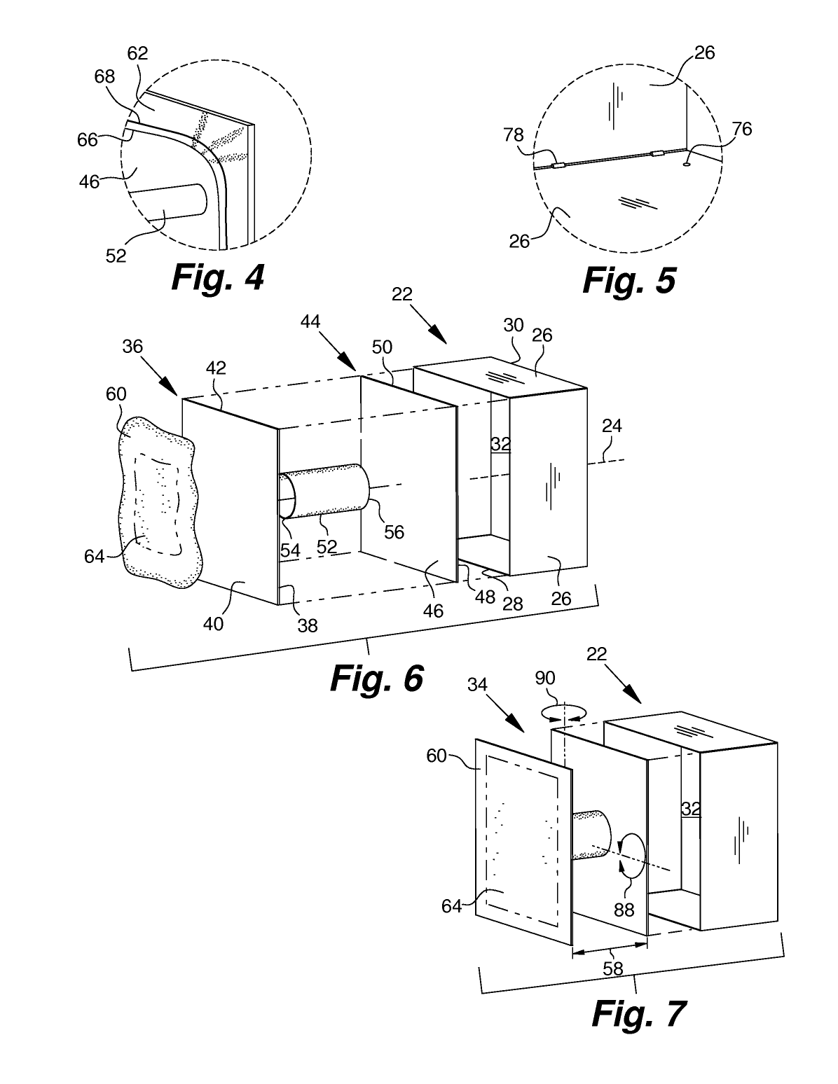

The first display substrate 60 and second display substrate 62 can be comprised of fabric or other flexible material suitable for use as a substrate upon which graphics can be mounted, printed or projected. Embodiments typically comprise a first graphic design 64 affixed to the first display substrate 60. Similarly, embodiments with a second display substrate 62 typically include a second graphic design (not shown) affixed thereto. The first display substrate 60 and second display substrate 62 may be substantially stretchable, thereby helping to retain a tensioned state when in wrapped association with the first panel 36 and second panel 44, respectively. Referring to FIG. 4, in certain embodiments, the first display substrate 60 and second display substrate 62 may each include a substrate periphery 66 and an elastic portion 68 generally thereat. The elastic portion 68 is generally adapted to removably retain the display substrate in wrapped association with its respective panel.

Referring now to FIGS. 2 and 13 for illustration, embodiments of the wrap-mount fabric display system 20 are generally designed to be self-stabilizing in that they are able to be placed on a supportive surface 92 and maintain the spatial orientation of the first panel 36 and second panel 44 with respect to the supportive surface 92 without the aid of any external support mechanisms. To accomplish this, the base portion 84 of the outer frame element 22 is typically sized, particularly with respect to outer frame element height 86, to inhibit tipping of the wrap-mount fabric display system 20.

To reduce the cost and manufacturing complexity of the display system, embodiments in accordance with the present invention generally do not rely on typical outer frame features such as lips and rabbets to maintain the upright orientation of the first panel 36 and second panel 44. Rather, as illustrated for example in FIG. 2, such orientation is maintained in large part by the fixed distance 58 between the panels (36 and 44), the width 80 of the bottom edges of the panels, the rigidity of the connection between the panels, or some combination thereof. The fixed distance 58 may also provide substantial storage space between the first panel 36 and second panel 44. This storage space may be used, for example, to efficiently transport and concealingly store additional stock of the product that the respective display system is used to advertise.

Similarly, with reference to FIG. 7, the orientation of the panels (36 and 44), particularly in rotational directions 88 and 90, are maintained with respect to the outer frame element 22 largely as a result of the fixed distance 58 between the panels and by the close fit between each of the panel peripheral edges (42 and 50) and the outer frame element 22, or some combination thereof. These clearances should generally be tight enough to eliminate the appearance of gaps between respective display substrate (60 or 62) and the outer frame element 22, but loose enough to allow the inner frame element 34 to be easily removed from its inserted configuration while a display substrate is in wrapped association with its respective panel. In particular embodiments, the inner frame element 34 is removably axially secured in its inserted configuration by way of, for example, frictional engagement between the first display substrate 60 and the outer frame element 22. This is most likely to be the case in embodiments in which the fit between the panel peripheral edges and the outer frame element are particularly close.

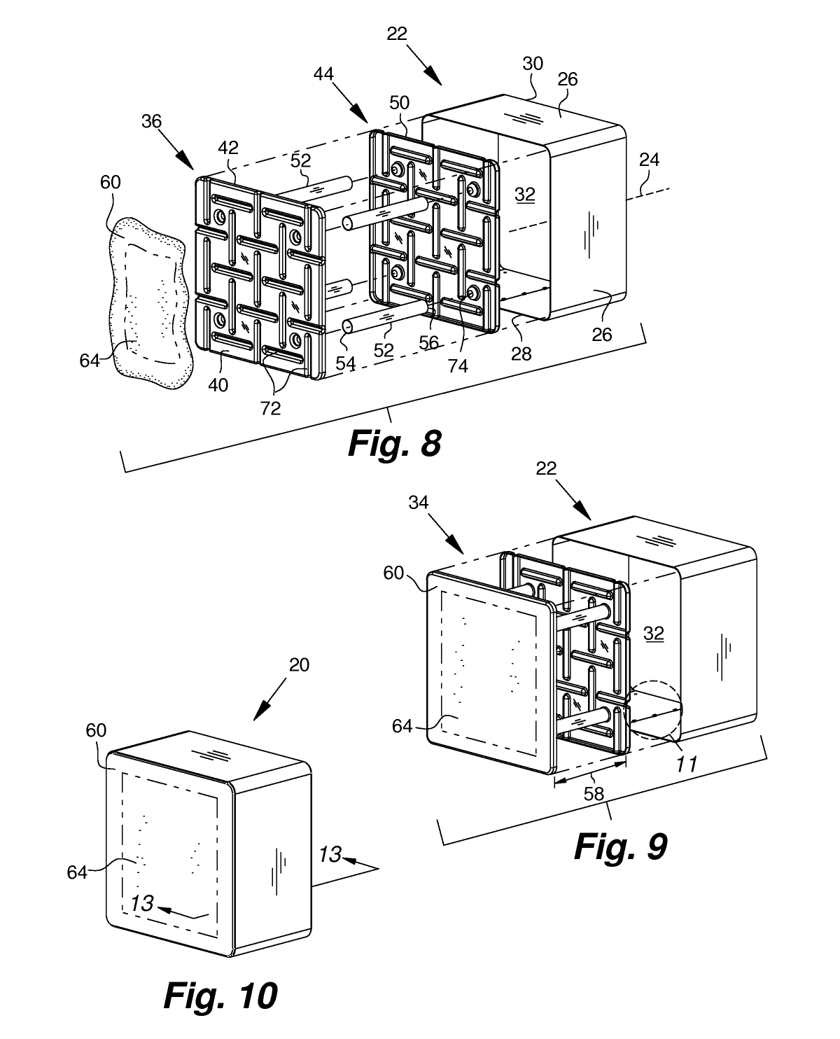

In embodiments, the first panel 36 and the second panel 44 are substantially formed of wood, cardboard, light-gauge plastic or sheet metal. For example, in the embodiment illustrated in FIGS. 1-3, the panels may each be made of white-faced brown corrugated cardboard with a thickness of a quarter inch. The first panel 36 and the second panel 44 are typically opaque so as to improve the visual appeal of the fabric substrate in wrapped association therewith. Further, the panels are typically each substantially flat planar and generally parallel with respect to each other. However, as illustrated in FIGS. 8-9, for example, the first panel 36 and second panel 44 of some embodiments may take advantage of even lighter-gauge plastic by including a multiplicity of integrally-formed stiffeners 72 generated by way of, for example, vacuforming or thermoforming processes. The stiffeners 72 allow the lighter-gauge panel to resist bending or buckling deformation under stress caused by, for example, the compression forces introduced by the elasticity or weight of the particular display substrate in wrapped association with the panel. Similarly, the first panel 36 and second panel 44 may also include integrally-formed attachment bosses 74 adapted to aligningly engage each connective member 52 at its first end 54 and second end 56, respectively. If so desired, translucent plastic may be used in the formation of such panels and their respective connective members 52 to allow backlighting to reach the display substrate (60 or 62) in wrapped association with the respective panel.

The detailed description of embodiments of the wrap-mount fabric display system is intended merely to provide examples, and is in no way intended to limit the scope of the appended claims to these described embodiments. Accordingly, modifications to the embodiments described are possible, and it should be clearly understood that the invention may be practiced in many different ways than the embodiments specifically described below, and still remain within the scope of the claims.

What is claimed is:

1. A wrap-mount fabric display system comprising:
(a) an outer frame element having a main axis, a multiplicity of generally uninterrupted planar sides distributed thereabout and a first peripheral edge, said sides generally defining a lateral periphery of a cavity, said cavity being generally axially open and having a depth along said main axis;
(b) an inner frame element having an inserted configuration and being adapted to be axially inserted into said cavity toward said inserted configuration, said inner frame element including:
(i) a first panel having a first panel inner face, a first panel outer face and a first panel peripheral edge;
(ii) a second panel having a second panel inner face, a second panel outer face and a second panel peripheral edge; and
(iii) a connective member having a first end and a second end, said connective member being adapted for attachment to said first panel inner face by way of said first end and to said second panel inner face by way of said second end such that said connective member maintains said first panel and said second panel at a fixed distance from one another; and
(c) a first display substrate, said first display substrate being generally flexible and adapted to be placed in wrapped association with said first panel such that said first display substrate substantially envelops said first panel outer face, at least a portion of said first panel peripheral edge, and at least a portion of said first panel inner face.

2. A wrap-mount fabric display system as defined in claim 1 further comprising a second display substrate, said second display substrate being adapted to be placed in wrapped association with said second panel such that said second display substrate substantially envelops said second panel outer face, at least a portion of said second panel peripheral edge, and at least a portion of said second panel inner face.

3. A wrap-mount fabric display system as defined in claim 1 comprising a multiplicity of said connective members.

4. A wrap-mount fabric display system as defined in claim 1 in which said inner frame element is removably axially secured substantially within said cavity by way of frictional engagement between said first display substrate and said outer frame element when said inner frame element is in said inserted configuration.

5. A wrap-mount fabric display system as define in claim 1 further comprising a first graphic design affixed to said first display substrate.

6. A wrap-mount fabric display system as defined claim 1 in which said first display substrate includes a substrate periphery and an elastic portion generally thereat, said elastic portion being adapted to removably retain said first display substrate in said wrapped association.

7. A wrap-mount fabric display system as defined in claim 1 in which said first display substrate is substantially stretchable.

8. A wrap-mount fabric display system as defined in claim 1 in which said first display substrate is made substantially of fabric.

9. A wrap-mount fabric display system as defined in claim 1 in which said outer frame element is substantially formed from flat stock of metal or plastic.

10. A wrap-mount fabric display system as defined in claim 1 in which said first panel and said second panel are substantially formed of wood, cardboard, light-gauge plastic or sheet metal.

11. A wrap-mount fabric display system as defined in claim 1 in which said connective member is substantially formed of wood, cardboard, light-gauge plastic or sheet metal.

12. A wrap-mount fabric display system as defined in claim 1 in which said first panel peripheral edge and said second panel peripheral edge each have the same number of sides as said outer frame element.

13. A wrap-mount fabric display system as defined in claim 1 in which said first panel and said second panel are each substantially planar.

14. A wrap-mount fabric display system as defined in claim 1 in which said first panel and said second panel each include a multiplicity of integrally-formed stiffeners.

15. A wrap-mount fabric display system as defined in claim 1 in which said first panel and said second panel each include an integrally-formed attachment boss, said attachment bosses being adapted to aligningly engage said connective member at said first end and said second end, respectively.

16. A wrap-mount fabric display system as defined in claim 1 in which said first panel outer face is approximately adjacent said first peripheral edge when said inner frame element is in said inserted configuration.

17. A wrap-mount fabric display system comprising:
(a) an outer frame element having a main axis, a multiplicity of generally uninterrupted planar sides distributed thereabout and a first peripheral edge, said sides generally defining a lateral periphery of a cavity, said cavity being generally axially open and having a depth along said main axis;
(b) an inner frame element having an inserted configuration and being adapted to be axially inserted into said cavity toward said inserted configuration, said inner frame element including:
(i) a first panel having a first panel inner face, a first panel outer face and a first panel peripheral edge, said first panel peripheral edge having the same number of sides as said outer frame element;
(ii) a second panel having a second panel inner face, a second panel outer face and a second panel peripheral edge, said second panel peripheral edge having the same number of sides as said outer frame element; and
(iii) a connective member having a first end and a second end, said connective member being adapted for attachment to said first panel inner face by way of said first end and to said second panel inner face by way of said second end such that said connective member maintains said first panel and said second panel at a fixed distance from one another; and
(c) a first display substrate with a first graphic design affixed thereto, said first display substrate being generally flexible, made substantially of fabric, and adapted to be placed in wrapped association with said first panel such that said first display substrate substantially envelops said first panel outer face, at least a portion of said first panel peripheral edge, and at least a portion of said first panel inner face.

18. A wrap-mount fabric display system as defined claim 17 in which:
(a) said first display substrate includes a substrate periphery and an elastic portion generally thereat, said elastic portion being adapted to removably retain said first display substrate in said wrapped association; and
(b) said first panel and said second panel are each substantially flat planar and generally parallel with respect to each other.

19. A wrap-mount fabric display system as defined claim 17 in which:
(a) said outer frame element is substantially formed from flat stock of metal or plastic;
(b) said first panel and said second panel are substantially formed wood, cardboard, light-gauge plastic or sheet metal; and
(c) said connective member is substantially formed of wood, cardboard, light-gauge plastic or sheet metal.

20. A wrap-mount fabric display system comprising:
(a) an outer frame element having a main axis, a multiplicity of generally uninterrupted planar sides distributed thereabout and a first peripheral edge, said sides generally defining a lateral periphery of a cavity, said cavity being generally axially open and having a depth along said main axis, said outer frame element being substantially formed from flat stock of metal or plastic;
(b) an inner frame element having an inserted configuration and being adapted to be axially inserted into said cavity toward said inserted configuration, said inner frame element including:
(i) a first panel having a first panel inner face, a first panel outer face and a first panel peripheral edge, said first panel peripheral edge having the same number of sides as said outer frame element, said first panel being substantially formed of wood, cardboard, light-gauge plastic or sheet metal;
(ii) a second panel having a second panel inner face, a second panel outer face and a second panel peripheral edge, said second panel peripheral edge having the same number of sides as said outer frame element, said second panel being substantially formed of wood, cardboard, light-gauge plastic or sheet metal; and
(iii) a multiplicity of connective members each having a first end and a second end, said connective members being adapted for attachment to said first panel inner face by way of respective said first end and to said second panel inner face by way of respective said second end such that said connective members maintain said first panel and said second panel at a fixed distance from one another, said fixed distance being approximately equal to said depth; and
(c) a first display substrate with a first graphic design affixed thereto, said first display substrate being generally flexible, made substantially of fabric, and adapted to be placed in wrapped association with said first panel such that said first display substrate substantially envelops said first panel outer face, at least a portion of said first panel peripheral edge, and at least a portion of said first panel inner face, said first display substrate including a substrate periphery and an elastic portion generally thereat, said elastic portion being adapted to removably retain said first display substrate in said wrapped association
